(19) United States
(12) Patent Application Publication
(10) Pub. No.: US 2004/0188474 A1
(43) Pub. Date: Sep. 30, 2004

(54) Collapsible/flexible pouring attachment

(75) Inventor: Marguerite LaSonya Johnston Wills, Farmington Hills, MI (US)

Correspondence Address: Marguerite LaSonya Johnston Wills, 38337 Spring Lane, Farmington Hills, MI, 48331-3757, US

(73) Assignee: Marguerite LaSonya Johnston Wills, Farmington Hills, MI

(21) Appl. No.: 10/776,699

(22) Filed: Feb. 12, 2004

Related U.S. Application Data
(60) Provisional application No. 60/447,308, filed on Feb. 14, 2003.

(51) Int. Cl. B67D 3/00

(52) U.S. Cl. 222/527

(57) ABSTRACT

A Collapsible/Flexible Pouring Attachment that improves the safety and pouring of fluid from a plastic bottle and/or container. It enhances the overall packaging of automotive lubricants, household chemicals, agricultural products and the like by eliminating the burden of locating a funnel to aid in dispensing. It has a bellowed pour spout, which makes it collapsible, flexible, retractable, and expandable, as well as maintain its ‘locked’ position. It has a dual threaded base (internal and external) that enables it to attach to a cap and a bottleneck using a single point of connection.

When the bellows are collapsed a cap can be screwed onto the external thread of the dual threaded base, such that the bellowed tubular spout is concealed and screwed in the cap's interior. This feature allows the cap and the bellowed tubular spout and the dual threaded base to be manipulated as a single unit. Assembled in this way, it can be fed into a capping machine and positioned and rotated like a standard cap. This is particularly beneficial in mass production. It does not interrupt the high volume and high speed mass production required to fill and cap bottles.

Another valuable feature of the Collapsible/Flexible Pouring Attachment is it mirrors the existing relationship, between a bottle and a cap, that consumers are accustom to encountering. There is little-to-no learning curve to utilize this package improvement.

With its robust set of features the Collapsible/Flexible Pouring Attachment provides all of the benefits of a custom dispenser and circumvents all of the deficiencies of external dispensers. It is safer, more effective and convenient. It eliminates ‘free-hand’ pouring. It is always accessible because it is attached to the bottle/container. It is a pour spout, a closure and an intricate component of the packaging.

This Non-Provisional Utility patent application replaces U.S. Provisional Utility patent application serial No. 60/447,308.

### CROSS-REFERENCES(S) TO RELATED APPLICATION(S)

This application is related to U.S. patent Ser. No. 29/183,474, granted Dec. 2, 2003 and U.S. Provisional Utility patent application serial No. 60/447,308.

### STATEMENT REGARDING FEDERAL SPONSORED RESEARCH AND DEVELOPMENT

No Federal Sponsored Research and Development monies funded this patent application or the related patent and patent application.

### BACKGROUND OF THE INVENTION

Bottles/containers containing automotive lubricants, household chemicals, agricultural products and the like are ill equipped to dispense without an exterior dispensing device. Exterior dispensing devices on the market (e.g. funnels, valves, tubes) are limited. They are rigid, i.e. not adaptable or flexible; they are restricted in length/range, e.g. regarding motor oil, a funnel flask can dispense into an engine's crankshaft, but it cannot reach the transmission intake; they require cleaning and storage for reuse, i.e. the value is locked into the number of uses and accessibility; and they are sold-separately from the bottle/container, e.g. when a consumer purchases motor oil, outside of having a funnel readily available, the consumer cannot effectively dispense the oil.

### BRIEF SUMMARY OF THE INVENTION

The Collapsible/Flexible Pouring Attachment is applicable to the following markets: agricultural, automotive, aviation household, marine and water/beverage. It is flexible, retractable, collapsible, conceal-able and attachable. The bellowed tubular section enables the invention to extend to various lengths and to reach difficult angles, as well as maintain a ‘locked’ position such that it does not move unless forcibly impacted. The dual threaded base enables the invention to secure to both a bottle/container's threaded opening (exterior) and a cap (interior) with the same point of connection. This invention can be attached separately from the cap, as a spout, or as a single unit, wherein the bellowed tubular section is securely attached to the interior of a cap.

This invention circumvents all of the deficiencies of external dispensers. Some of which are:

a) External dispensers are not always available;

b) They are not adaptable, i.e. there is a separate and different dispenser required per type of application;

c) The value of the external dispenser is locked into the number of uses; and

d) They are difficult to clean and must be stored for reuse.

The Collapsible/Flexible Pouring Attachment overcomes these barriers.

### BRIEF DESCRIPTION OF THE SEVERAL VIEWS OF THE DRAWINGS

The broken lines in the Figures are for illustrative purposes only and form no part of the claimed invention. A description of each of the figures of the drawings is as follows:

FIG. 1 is a top perspective view of the collapsible/flexible pouring attachment in the collapsed position;

FIG. 2 is a bottom perspective view of the collapsible/flexible pouring attachment in an inverted position to illustrate the internal threads of the attachment;

FIG. 3 is a perspective view of the collapsible/flexible pouring attachment in an expanded and flexed position;

FIG. 4 is a side view of the collapsible/flexible pouring attachment in FIG. 1 being illustrated with a conventional closure cap;

FIG. 5 is a perspective view of the collapsible/flexible pouring attachment in a collapsed position disposed on a fluid container in addition to the closure cap;

FIG. 6 is a perspective view of the collapsible/flexible pouring attachment disposed on a fluid container and drawn to an expanded and flexed position; and

FIG. 7 is a side view of the collapsible/flexible pouring attachment disposed on a fluid container in the collapsed position and covered by a closure cap.

### DETAILED DESCRIPTION OF THE INVENTION

There are several U.S. patented inventions that address the same or similar problem of fluid dispensing. A detailed summary, identifying those patents, is contained in the Information Disclosure Statement of Applicant document of this application. As a matter of principle and law, every attempt was made to list all U.S. patented inventions with related and relevant features and/or functionalities pertaining to this utility patent application. However, none of these patented inventions provide the functionalities of the invention for which this utility patent application claims as an original invention.

There are two U.S. patents that warrant a closer examination. For instance, U.S. Pat. No. 6,112,949 has multiple caps: “an inner cap connected to a bottle and an outer cap is detachably connected to the inner cap” it has “ . . . a gasket inside the inner cap and sealing against the end of the dispenser tube . . . ” and “ . . . the outer cap is connected to the inner cap by a bayonet fitting . . . ” This invention is a complex assembly of dual caps, a gasket, a tube, and a bayonet fitting.

The other U.S. patented invention worthy of a closer examination is U.S. Pat. No. 4,921,147. It is similar to U.S. Pat. No. 6,112,949 in they share a tube that is attached to a bottleneck by a gasket: “a main elongated tubular section, a connector member fixed at one end of the said tubular section and releasable secured to said outlet.”

The fundamental differences between U.S. Pat. No. 6,112,949 and U.S. Pat. No. 4,921,147 and the original invention claimed in this utility patent application, entitled Collapsible/Flexible Pouring Attachment, are:

a) The Collapsible/Flexible Pouring Attachment is a simple assembly: a bellowed tubular section, having a dual threaded base (internal/external thread); this is unlike U.S. Pat. No. 6,112,949 and U.S. Pat. No. 4,921,147.

b) The Collapsible/Flexible Pouring Attachment has a single point of connection between the cap and the bottleneck, which is the dual threaded base of the bellowed tubular section, which is a unique feature. U.S. Pat. No. 6,112,949 has two caps, connecting at several different points (1. the tube and the gasket, 2. the outer cap and the inner cap, 3. the bayonet fitting and the tube and 4. the inner cap and the bottleneck). U.S. Pat. No. 4,921,147 has two connecting points neither includes a cap.

c) The Collapsible/Flexible Pouring Attachment performs its functions without the introduction of additional parts, i.e. the bellowed tubular section, having a dual threaded base, can attach to a bottleneck and perform the function of a pouring spout. Whereas, neither U.S. Pat. No. 6,112,949 and U.S. Pat. No. 4,921,147 performs a single function without its assembled parts.

d) U.S. Pat. No. 6,112,949 and U.S. Pat. No. 4,921,147 both have a tube; however, it must be attached using gasket or connector. The Collapsible/Flexible Pouring Attachment is not attached by a gasket or connector; and

e) The Collapsible/Flexible Pouring Attachment's assembly is unique, as well. The dual threaded base of the bellowed tubular section enable it to be secured to a cap's interior thread, thereby concealing the bellowed tubular section beneath a cap.

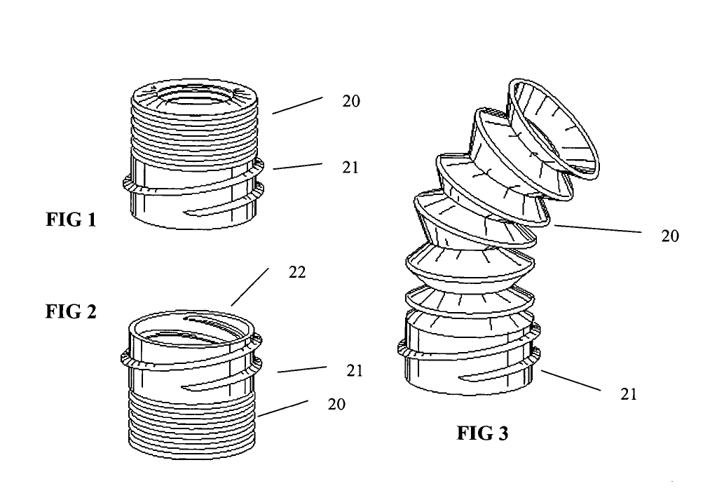

As illustrated in FIG. 1 and FIG. 2, the Collapsible/Flexible Pouring Attachment performs the functions of a spout and an attachment. The dual threaded base (21 and 22) enable the bellowed tubular section (20) to attach to a threaded bottleneck void of an external apparatus.

As illustrated in FIG. 3, the Collapsible/Flexible Pouring Attachment can maintain an angled position, whereby the bellowed tubular section (20) does not move unless forcibly impacted. This enables the Collapsible/Flexible Pouring Attachment to reach otherwise difficult to access openings.

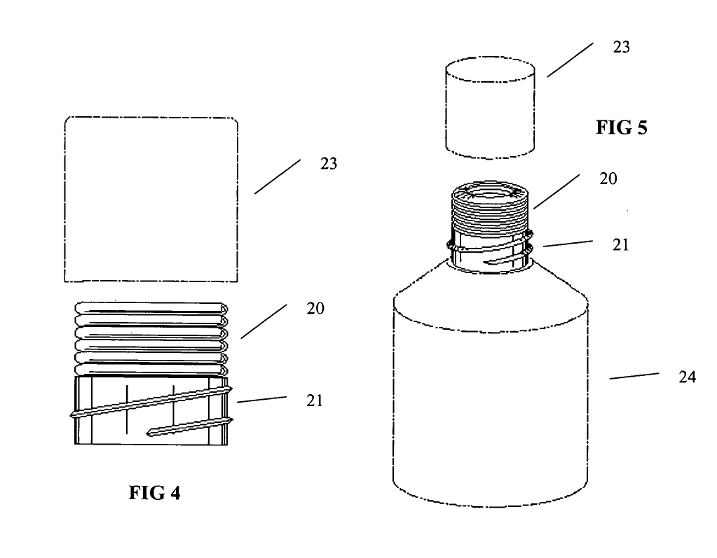

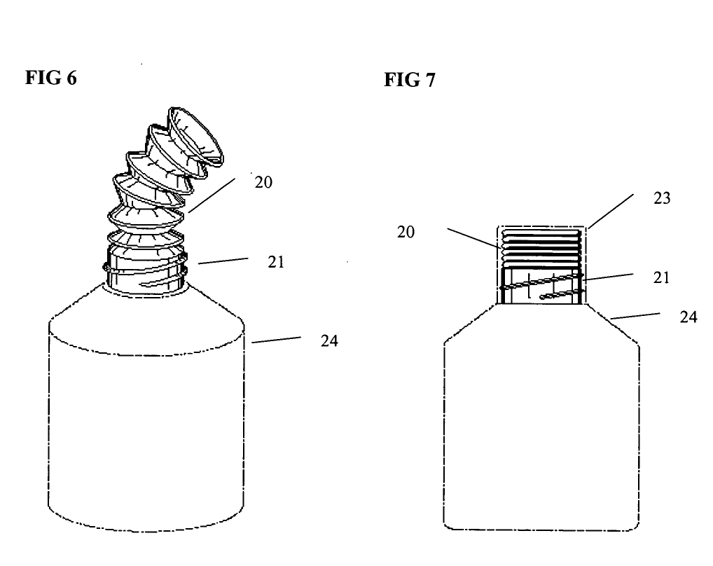

As illustrated in FIG. 4 and FIG. 5, the Collapsible/Flexible Pouring Attachment can be neatly concealed beneath a cap (23); this feature of the original invention offers tremendous advantages for mass production. Because the Collapsible/Flexible Pouring Attachment can be concealed beneath a cap, capping machinery can manipulate (rotate and position) the Collapsible/Flexible Pouring Attachment, as if it was a single unit and not two assembled components. Having a single point of connection between a cap (23) and a bottle (24), the Collapsible/Flexible Pouring Attachment mirrors the existing relationship between a bottle (24) and a cap (23) in the current production environment.

As illustrated in FIG. 7, the bellowed tubular section (20) is in the collapsed and concealed position, which is the position this original invention will be presented to consumers. This original invention does not alter the mechanics of the bottle; therefore, consumers will require minimal instruction to use the Collapsible/Flexible Pouring Attachment. There is little-to-no learning curve to introduce this original invention.

I claim, as an original invention, the following:

1. A bellowed tubular pouring spout attachment, comprising:
A bellowed tubular section, having a series of accordion-like circumferential folds sealed together by connections resembling pleats;
Wherein said bellowed tubular section is collapsible, flexible, retractable, expandable and conceal-able; and
Wherein said bellowed tubular section can be ‘shaped’ and ‘locked’ into a set position, such that it does not move unless forcibly impacted.

2. A bellowed tubular pouring spout attachment according to claim 1 . . .
Wherein the base of the bellowed tubular section comprises a dual thread, external and internal, such that a device/component can be screwed into/onto each thread, e.g. the internal thread to the external thread of a bottleneck and the external thread to the internal thread of a cap;
Wherein said dual threaded base is injection molded, having been joined to said bellowed tubular section by over-molding, spin welding or other like process of sealing the two components together such that there is no separation between the two;
Wherein said dual threaded base has a circular opening that is linear to the circular opening in said bellowed tubular section; and
Wherein said dual threaded base is larger in size in relation to the width of said bellowed tubular section.

3. A bellowed tubular pouring attachment according to claim 1 and claim 2 . . .
Wherein said bellowed tubular section can be concealed by collapsing said bellowed tubular section and securing a cap, having an internal thread, to the external thread of said dual threaded base of said bellowed tubular section, thereby concealing said bellowed tubular section and said dual threaded base in the interior of the cap; whereby neither said bellowed tubular section nor said dual threaded base are visible from the exterior of the cap; whereby, in this position (collapsed and concealed in the interior of a cap) said bellowed tubular section and said dual threaded base can be manipulated as a standard cap.
